(19) United States
(12) Patent Application Publication
(10) Pub. No.: US 2023/0173991 A1
(43) Pub. Date: Jun. 8, 2023

(54) Paddleboard Trailer Device

(71) Applicant: Frederick Warn, DeWitt, MI (US)

(72) Inventor: Frederick Warn, DeWitt, MI (US)

(21) Appl. No.: 18/054,576

(22) Filed: Nov. 11, 2022

Related U.S. Application Data
(60) Provisional application No. 63/287,264, filed on Dec. 8, 2021.

(51) Int. Cl. B60R 9/08

(52) U.S. Cl. CPC B60R 9/08

(57) ABSTRACT

The present invention relates generally to the field of trailers. More specifically, the present invention relates to a paddleboard trailer device that is comprised of a top surface further comprised of at least one board receiving structure, at least one cooler box, at least one main storage box, and a rear surface with at least one internal compartment. The base of the device further preferably resembles a utility trailer and is durable and rigid such that it can support the weight of multiple paddleboards or surfboards and other heavy objects. The device is also comprised of a board receiving structure that securely and efficiently organizes the boards to prevent damage and enhance accessibility. In this manner, the device can be attached to any vehicle with a trailer hitch, such that a large group of people can easily travel to a water location in a minimal number of vehicles.

### CROSS-REFERENCE TO RELATED APPLICATION

The present application claims priority to, and the benefit of, U.S. Provisional Application No. 63/287,264, which was filed on Dec. 8, 2021, and is incorporated herein by reference in its entirety.

### FIELD OF THE INVENTION

The present invention relates generally to the field of trailers. More specifically, the present invention relates to a paddleboard trailer device that is comprised of a top surface further comprised of at least one board receiving structure, at least one cooler box, at least one main storage box, and a rear surface with at least one internal compartment. The base of the device further preferably resembles a utility trailer and is durable and rigid such that it can support the weight of multiple paddleboards or surfboards and other heavy objects. The device is also comprised of a board receiving structure that securely and efficiently organizes the boards to prevent damage and enhance accessibility. In this manner, the device can be attached to any vehicle with a trailer hitch such that a large group of people can easily travel to a water location with all their belongings in a minimal number of vehicles.

Accordingly, the present disclosure makes specific reference thereto. Nonetheless, it is to be appreciated that aspects of the present invention are also equally applicable to other like applications, devices, and methods of manufacture.

### BACKGROUND

In the summer months or places with generally warm weather year-round, water sports and activities can be a great way to spend time. Paddleboarding and surfing are two simple water activities in which a board is the only equipment required for doing the activity. However, when travelling to a pond, lake, beach, or other body of water, paddleboards and surfboards may be difficult to transport. The boards may take up a lot of space, and if travelling with many friends or a large family, there may not be enough room to fit a single or multiple boards in or on a vehicle. Even if there is the room for boards during transportation, it is possible the boards may become damaged as they may be transported without being properly secured, thus leading to the boards moving around and potentially becoming damaged.

Therefore, there exists a long-felt need in the art for a paddleboard trailer device. There also exists a long-felt need in the art for a paddleboard trailer device capable of attaching to a transportation vehicle to transport paddleboards and surfboards from a first location to a water location. Further, there exists a long-felt need in the art for a paddleboard trailer device that can easily receive and secure multiple paddleboards. In addition, there exists a long-felt need in the art for a paddleboard trailer device that allows room for coolers and other storage items for trips to water locations in which food, beverages, and supplies may be desired.

The subject matter disclosed and claimed herein, in one embodiment thereof, comprises a paddleboard trailer device. The device is primarily comprised of a top surface further comprised of at least one board receiving structure, at least one cooler box, at least one main storage box, and a rear surface with at least one internal compartment. The base of the device further preferably resembles a utility trailer and is durable and rigid such that it can support the weight of multiple paddleboards, surfboards, and other objects. The device is also comprised of a board receiving structure that securely and efficiently organizes the boards to prevent damage and enhance accessibility. In this manner, the device can be attached to any vehicle with a trailer hitch such that a large group of people can easily travel to a water location in a minimal amount of vehicles, and while maximizing the amount of paddleboards or surfboards that can be taken.

In this manner, the paddleboard trailer device of the present invention accomplishes all the forgoing objectives and provides a means to transport paddleboards and surfboards from a first location to a water location. Further, the device can attach to vehicles capable of holding any trailer such that a plurality of paddleboards and surfboards may be easily secured and transported. In addition, the device provides additional room for storage of other items, such as spare tires, coolers, and lights to assist loading and unloading the paddleboards and surfboards during lowlight conditions.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paddleboard trailer device. The device is primarily comprised of a top surface further comprised of at least one board receiving structure, at least one cooler box, at least one main storage box, and a rear surface with at least one internal compartment. The base may have the general appearance of a utility trailer with storage racks. The base may also be made of a plurality of materials that are commonly used for making trailers. However, the base is preferably made of wood or metal.

The base is further comprised of a top surface in which at least one, but preferably two board receiving structures, are fixedly attached. Each board receiving structure is further comprised of at least two vertical frame members and at least one horizontal frame member. A plurality of paddleboards or surfboards may be pushed into a board receiving structure and slid through the structure until the board is in contact with both board receiving structures. The horizontal frame members of the board receiving structure may further be comprised of a padding and/or a roller to prevent damage or improve accessibility to the boards. In addition, at least one support frame member may attach to the top surface of the base and a vertical frame member to provide additional support against wind and other horizontal forces.

The base of the device may also be comprised of additional storage space for items other than the boards. A cooler box, which may receive a transportable cooler, may be fixedly or removably attached to the top surface of the base. The cooler box may have partial walls to prevent the cooler from sliding off the base as well as an at least one strap to secure the cooler to the base. The at least one strap may also be used to secure the paddleboards, surfboards, or other items to the base. Further, a generally rectangular main storage box may be fixedly attached to the top surface of the base. The main storage box is further comprised of an at least one hinge which allows the main storage box to open and close and an at least one lock to prevent the main storage box from opening or being opened unintentionally. In addition, a rear surface of the base provides additional storage via a compartment for the paddles or other equipment used during paddleboarding. The compartment is protected by an at least one cover which may open via an at least one hinge and be sealed shut using an at least one lock.

The base of the device is further comprised of a bottom surface. At least one axle may be fixedly attached to the bottom surface of the base. At least one but preferably two wheels attach to either end of the axle and are protected via an at least one wheel cover. In addition, a main trailer shaft is fixedly attached to the bottom surface of the base and extends outward towards the vehicle from which it gets towed. To attach to the vehicle, the main trailer shaft is comprised of a hitch that attaches to the hitch of the vehicle. The main trailer shaft is also comprised of a support leg, a spare tire, and an electrical box. The support leg allows the device to stand alone when it is not attached to a vehicle. The spare tire is attached to the main trailer shaft via a spare tire holder. The electrical box draws power from the vehicle and distributes it to an LED light and the turn signals. The LED light may be used to illuminate the area during lowlight hours and the turn signals on the rear surface of the base work in conjunction with the turn signals of the vehicle to communicate with other drivers on the road.

Accordingly, the paddleboard trailer device of the present invention is particularly advantageous as it provides a means to transport paddleboards and surfboards from a first location to a pond, lake, beach, or other water location. Further, the device provides storage for a plurality of items such as, but not limited to, spare tires, coolers, wires, lights, straps, paddles, rafts, towels, and any other item that may be desirable for the destination. In addition, the device can attach to the trailer hitch of any vehicle such that a plurality of paddleboards and surfboards may be easily transported from storage to a desired location. In this manner, the paddleboard trailer device overcomes the limitations of existing headstones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a paddleboard trailer device of the present invention in accordance with the disclosed architecture;

FIG. 2 illustrates a perspective view of one potential embodiment of a paddleboard trailer device of the present invention in accordance with the disclosed architecture;

FIG. 3 illustrates a perspective view of one potential embodiment of a paddleboard trailer device of the present invention in accordance with the disclosed architecture;

FIG. 4 illustrates a perspective view of one potential embodiment of a paddleboard trailer device of the present invention in accordance with the disclosed architecture;

FIG. 5 illustrates a perspective view of one potential embodiment of a paddleboard trailer device of the present invention in accordance with the disclosed architecture; and

FIG. 6 illustrates a perspective view of one potential embodiment of a paddleboard trailer device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a paddleboard trailer device. There also exists a long-felt need in the art for a paddleboard trailer device capable of attaching to a transportation vehicle to transport a plurality of paddleboards and surfboards from a first location to a water location. Further, there exists a long-felt need in the art for a paddleboard trailer device that can easily receive and secure a plurality of paddleboards during transportation. In addition, there exists a long-felt need in the art for a paddleboard trailer device that allows room for coolers and other storage items for trips to water locations in which food, beverages, and supplies may be desired.

The present invention, in one exemplary embodiment, is comprised of a paddleboard trailer device that can be attached to a vehicle such that a plurality of paddleboards and surfboards may be transported safely and securely to a body of water. The device is primarily comprised of a top surface further comprised of at least one board receiving structure, at least one cooler box, at least one main storage box, and a rear surface with at least one internal compartment. The base may have the general appearance of a utility trailer with built-in storage racks and comprise additional space for additional storage. The base may also be made of a plurality of materials commonly used for making trailers but is preferably made of wood or metal.

The base is further comprised of a top surface in which at least one board receiving structure is fixedly attached. The board receiving structure is further comprised of at least two vertical frame members and at least one horizontal frame member. Preferably, a paddleboard or surfboard contacts two horizontal frame members at each end of the board creating a more stable and secure storage board receiving structure. The horizontal frame members as well as the vertical frame members may also be comprised of a padding to prevent the boards from being damaged during transportation or retrieval from or placement into the board receiving structure. A roller may be attached to each horizontal frame member of the board receiving structure. In one potential embodiment, the horizontal frame member may rotate along its longitudinal axis, allowing for the board receiving structure to receive the boards in a simpler manner. In addition, at least one support frame member may be fixedly attached to each vertical frame member to provide more stabilization to the board receiving structure. The support frame members may extend towards the top surface of the base at a forty-five-degree angle, generating a wider base and more stability against wind, bumps, and other forces that may occur during transportation.

The base of the device may also be comprised of additional space for storage of items other than paddleboards and surfboards. A cooler box may be fixedly or removably attached to the top surface of the base to keep food and drink cold during long periods of transportation, while camping, or in any other instance in which food needs to be kept at a lower-than-ambient temperature. A receiving point for the cooler box may be partially walled in to aid in securing the cooler box to the device. In one potential embodiment, the top surface of the base comes with a fixedly attached cooler box capable of insulating food and drink at a cooler temperature than the surroundings. In another potential embodiment, the top surface of the base may simply have a spot for one to place a cooler box of their own. To additionally secure any equipment attached to the device such as the cooler box, the paddleboards and surfboards, or any other items, and at least one strap may be used. The strap may have hooks to allow it to attach to different parts of the base, and it may be used on objects individually or collectively, such as using a single strap to secure all the paddleboards. A generally rectangular main storage box may also be fixedly attached to the top surface of the base of the device. The main storage box may open using at least one hinge and may be sealed shut using an at least one lock. In one potential embodiment, the main storage box may be sealed such that the main storage box is waterproof, preventing the items stored inside from getting wet. Storage may further be found on the rear surface of the base of the device. A compartment may be accessed from the rear surface of the body that stores paddles or other similar equipment. A cover protects this equipment during transportation or storage and may be opened via an at least one hinge. In addition, the cover for the compartment of the rear surface of the base may be locked shut using an at least one lock.

The base of the device is also comprised of a bottom surface. At least one axle is fixedly attached to the bottom surface of the base. At least one, but preferably two, wheels are attached to the axle, one at each end of the axle. The wheels allow the device to be pulled behind a vehicle with a minimal resistance on varying road surfaces. Each wheel of the device may have a wheel cover that is fixedly or removably attached to either the axle, the base, the wheel, or some combination of the aforementioned components. Also attached to the bottom surface of the base is at least one main trailer shaft that extends outward and may attach to a vehicle via an at least one hitch. The main trailer shaft has an at least one support leg that can support the trailer when it is not attached to a vehicle. The support leg can rotate and has at least one handle. In addition, the main trailer shaft is also comprised of a spare tire and an electrical box. The at least one spare tire is attached to the main trailer shaft via an at least one spare tire holder that extends from the main trailer shaft and bolts into the spare tire. The electrical box may be waterproof as it contains a wiring to electrically connect the device to the vehicle. The wiring of the electrical box may take power from the vehicle and use that power to illuminate an LED light for increased visibility during lowlight hours and synchronize an at least two turn signals on the rear surface of the base to indicate to other drivers during transportation when the driver is switching lanes, breaking, turning, etc.

Accordingly, the paddleboard trailer device of the present invention is particularly advantageous as it provides a means to transport paddleboards and surfboards from storage to a pond, lake, beach, or other water location. Further, the device can attach to any vehicle with a trailer hitch such that the boards may be transported safely and securely. In addition, the device has many compartments for storage of items other than boards that may be desirable for the destination. Therefore, the device eliminates the need for multiple vehicles or unsafe driving practices when travelling with friends or family to paddleboard or surf.

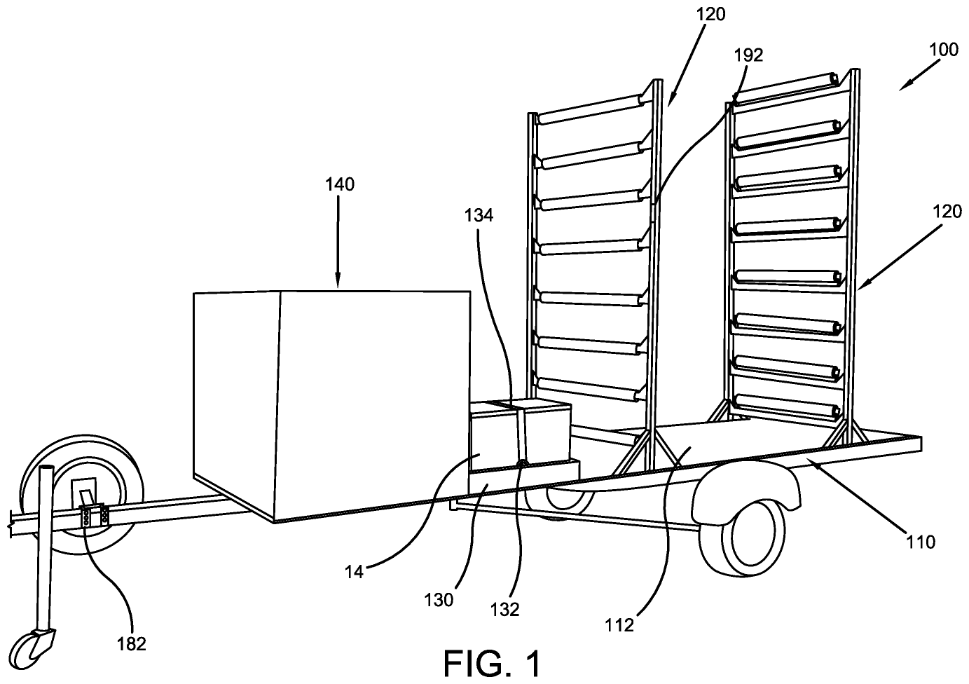

Referring initially to the drawings, FIG. 1 illustrates a perspective view of one potential embodiment of a paddleboard trailer device 100 of the present invention in accordance with the disclosed architecture. The device 100 is primarily comprised of a top surface 112 further comprised of at least one board receiving structure 120, at least one cooler box 130, at least one main storage box 140, and a rear surface 150 with at least one internal compartment 156. The base 110 of the device 100 may be generally rectangular and have the general appearance of a utility trailer. The base 110 may be made of a plurality of materials such as wood, but is preferably made of a metal such as, but not limited to, aluminum, an aluminum alloy, galvanized steel, untreated steel, carbon steel, alloy steel, iron, magnesium, copper, brass, bronze, zinc, titanium, tungsten, nickel, cobalt, tin, lead, silicon, etc.

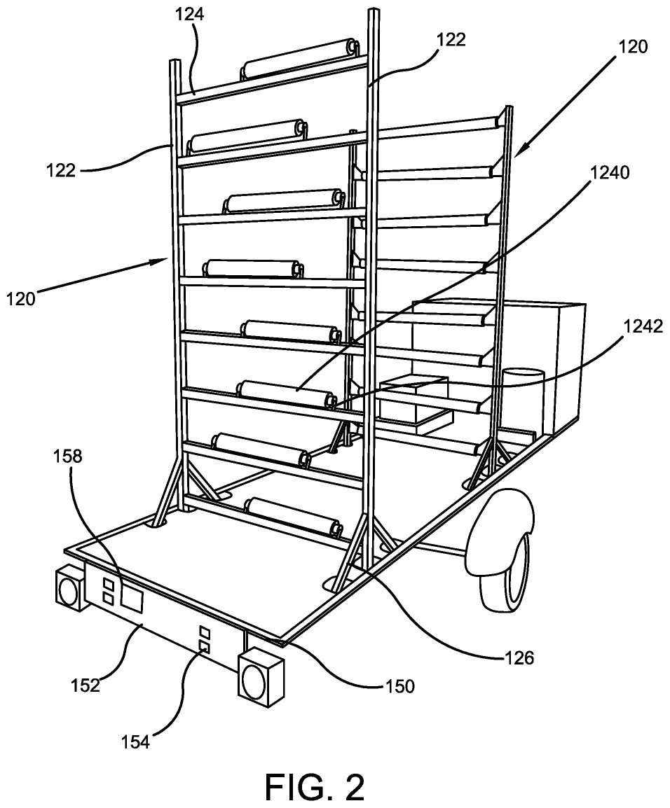

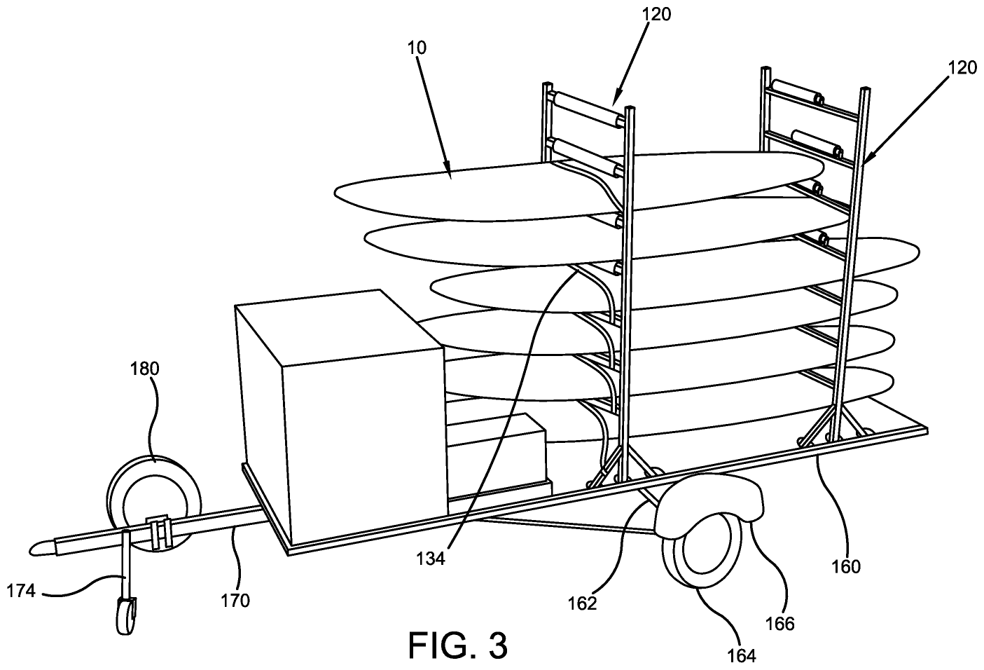

The base 110 of the device 100 is further comprised of a top surface 112 which has at least one board receiving structure 120 fixedly attached to the top surface 112. The board receiving structure 120 is further comprised of at least two vertical frame members 122 and at least one horizontal frame member 124, giving the board receiving structure 120 a generally rectangular shape. Preferably, two identical board receiving structures 120 are fixedly attached to the top surface 112 of the base 110 in line with one another thereby allowing a plurality of boards 10 (as best seen in FIG. 3) to lay flat, and wherein a horizontal frame member 124 of each board receiving structure 120 supports each end of each board 10. In one potential embodiment, each horizontal frame member 124 is comprised of a padding 1240 layer, such as a rubber or foam material, to prevent damage to the boards 10 during transportation. In another potential embodiment, each horizontal frame member 124 may be comprised of a roller 1242 that allows the horizontal frame member 124 to rotate about its axis. This rotation may allow the boards 10 to be placed into and taken out of the board receiving structure 120 with less friction and difficulty as they roll along the rollers 1242. In addition, the rollers 1242 of the horizontal frame members 124 may be comprised of a padding 1240 as well (as best seen in FIG. 2). Further, at least one support frame member 126 may be fixedly attached to each vertical frame member 122 and the top surface 112 of the base 110 to widen the base of the board receiving structure 120 making the structure 120 more stable against strong winds, bumps in the road, or other forces during transportation.

FIG. 3 illustrates a perspective view of one potential embodiment of a paddleboard trailer device 100 of the present invention in accordance with the disclosed architecture. The base 110 of the device 100 is comprised of additional space that may be used to store items other than boards 10. A cooler box 130 with a plurality of walls may form an area for a cooler 14 to be placed securely on the base 110. The cooler box 130 has at least one receiving point 132 for an at least one strap 134 to hook onto and hold the cooler 14 down during transportation. At least one strap 134 may additionally be used to secure the boards 10 in the board receiving structure 120 or any other items that may be loose or potentially damaged during transportation. The strap 134 may have hooks or other attachment components that allow it to attach to the base 110, board receiving structure 120, or another point on the device 100. The strap 134 may also be rubber, rope, and/or elastic.

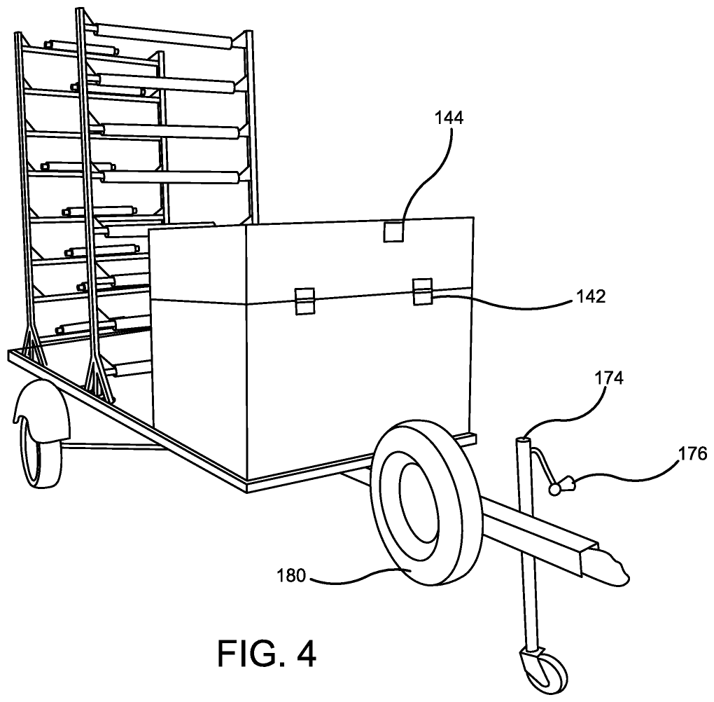

FIG. 4 illustrates a perspective view of one potential embodiment of a paddleboard trailer device 100 of the present invention in accordance with the disclosed architecture. A main storage box 140 acts as another storage compartment for items other than the boards 10 on the top surface 112 of the base 110. The main storage box 140 is generally rectangular in shape and can be filled with several storage items such as, but not limited to, noodles, rafts, floaties, goggles, towels, beach umbrellas, rope, bungee cords, harnesses, kites, etc. The main storage box 140 may open via an at least one hinge 142. In differing embodiments, the hinge 142 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. Further, the main storage box 140 may be comprised of a lock 144, securing the items inside. In differing embodiments, the lock 144 may be any lock type known in the art such as, but not limited to, a padlock, a key lock, a deadbolt, a knob lock, a cam lock, a lever handle lock, a biometric lock, etc.

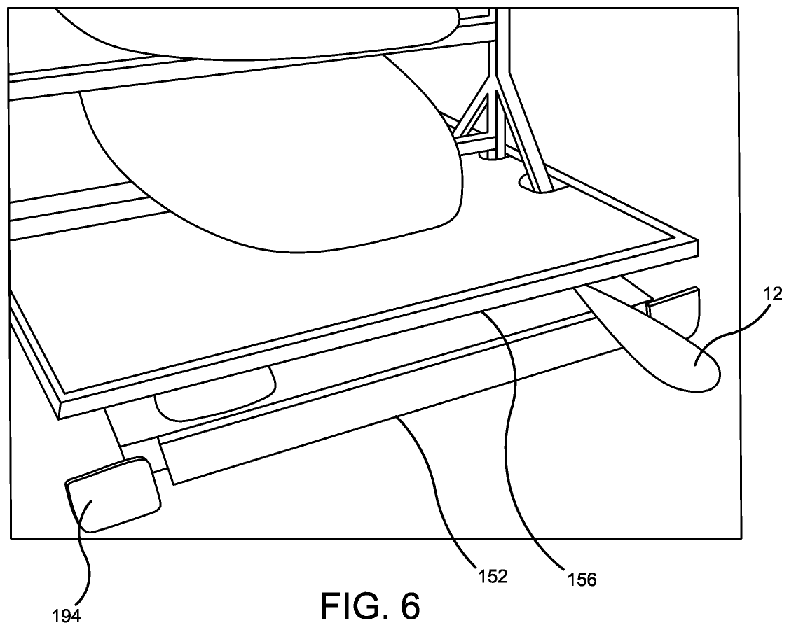

FIG. 6 illustrates a perspective view of one potential embodiment of a paddleboard trailer device 100 of the present invention in accordance with the disclosed architecture. The base 110 of the device 100 is further comprised of a rear surface 150 in which additional items may be stored. A cover 152 may conceal a storage compartment 156 and prevent any items contained inside from falling out of the compartment 156. In one potential embodiment, the cover 152 may be a singular piece in which it opens to show the contents inside via an at least one hinge 154. However, the cover 152 is preferably comprised of two sections. The two sections are connected via an at least one hinge 154 such that one section remains stationary, and the other section may fold downwards to expose the interior compartment 156. This compartment 156 may be used to store paddles 12 for their long and awkward shape but may be used to store any other items the user seems fit. Further, the cover 152 of the compartment 156 of the rear surface 150 of the base 110 may be secured in a closed position via an at least one lock 158. In differing embodiments, the lock 158 may be any lock type known in the art such as, but not limited to, a padlock, a key lock, a deadbolt, a knob lock, a cam lock, a lever handle lock, a biometric lock, etc. In addition to the compartment 156 on the rear surface 150 of the base 110, at least two turn signals 194 may be fixedly attached to the rear surface 150. The turn signals 194 are preferably in electrical communication with the vehicle that is towing the device 100 such that when the rear lights of the vehicle illuminate, whether it be from the turn signal or braking, the turn signals 194 of the device 100 illuminate as well.

The base 110 of the device 100 is also comprised of a bottom surface 160. Attached to the bottom surface 160 of the device 100 are the components that allow the device 100 to be towed by a vehicle. As best seen in FIG. 3, at least one axle 162 is fixedly attached to the bottom surface 160 of the base 110. Attached to the axle 162 is an at least one, but preferably two, wheels 164 in which each wheel 164 is located at the end of the axle 162. Each wheel additionally is comprised of at least one wheel cover 166. A main trailer shaft 170 also is fixedly attached to the bottom surface 160 of the base 110 of the device 100. The main trailer shaft 170 extends outwards from the base 110 towards the vehicle from which it is being towed. To attach to the vehicle, a hitch 172 of the main trailer shaft 170 may attach to the hitch of the vehicle. Preferably, the hitch 172 is a female hitch, allowing it to attach to the male hitch of the vehicle. However, the hitch 172 may be any hitch known in the art such that it can securely attach to the vehicle from which it is being towed. The main trailer hitch 170 is further comprised of an at least one support leg 174, further comprised of a handle 176. The support leg 174 may attach to the main trailer shaft 170 via an at least one hinge such that when the hitch 172 of the main trailer shaft 170 is connected to the hitch of a vehicle, the support leg 174 may fold upwards to align with the axis of the main trailer shaft 170. The handle 176 may be used to conveniently rotate the support leg 174 or guide the device 100 when it is not attached to a vehicle.

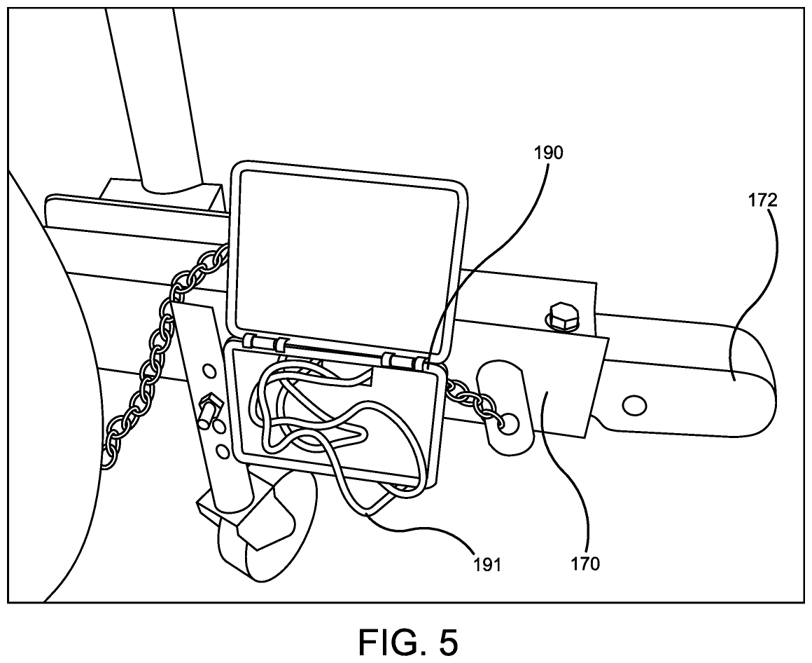

FIG. 5 illustrates a perspective view of one potential embodiment of a paddleboard trailer device 100 of the present invention in accordance with the disclosed architecture. The main trailer shaft 170 is further comprised of a spare tire holder 182 that holds an at least one spare tire 180 as well as a waterproof electrical box 190 that provides power to the electrical components of the device 100. The spare tire holder 182 may be fixedly attached to the main trailer shaft 170 and may bolt into a spare tire 180 in the case in which one of the wheels 164 of the device 100 goes flat. The electrical box 190 is comprised of the wiring 191 that allows the device 100 to draw power from the vehicle from which it is being towed. The electrical box 190 is preferably made waterproof by an O-ring, gasket, or other similar component and may be easily opened and closed for access. The electrical box 190 may also provide power to an LED light 192 that may be used to increase visibility during lowlight hours. The LED light 192 may be fixedly or removably attached to any component of the device 100, such as a vertical frame member 122 of the board receiving structure 120 (as best seen in FIG. 1). In one potential embodiment, the LED light 192 may be stored in the main storage box 140 until it is needed. The LED light 192 may then be hooked up to the electrical box 190 to receive power and provide light for the user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paddleboard trailer device” and “device” are interchangeable and refer to the paddleboard trailer device 100 of the present invention.

Notwithstanding the forgoing, the paddleboard trailer device 100 of the present invention and its various components can be of any suitable size and configuration as is known in the art without affecting the overall concept of the invention, provided that they accomplish the above-stated objectives. One of ordinary skill in the art will appreciate that the size, configuration and material of the paddleboard trailer device 100 as shown in the FIGS. are for illustrative purposes only, and that many other sizes and shapes of the paddleboard trailer device 100 are well within the scope of the present disclosure. Although the dimensions of the paddleboard trailer device 100 are important design parameters for user convenience, the paddleboard trailer device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paddleboard trailer device comprising:
a base comprised of a board receiving structure, a main storage box and a cooler box;
an internal compartment;
a wheel;
an axle;
an electrical box;
a trailer shaft comprised of a hitch;
a pair of turn signals; and
a strap.

2. The paddleboard trailer device of claim 1, wherein the board receiving structure is located on a top surface of the base.

3. The paddleboard trailer device of claim 1, wherein the base is comprised of a metal material.

4. A paddleboard trailer device comprising:
a base;
a pair of board receiving structures comprised of a padding layer;
a main storage box further comprised of a hinge;
a cooler box further comprised of a receiving point;
an internal compartment;
a wheel;
an LED;
an axle;
an electrical box;
a trailer shaft comprised of a hitch;
a pair of turn signals; and
a strap.

5. The paddleboard trailer device of claim 4, wherein the LED is located on the pair of board receiving structures.

6. The paddleboard trailer device of claim 5, wherein the pair of board receiving structures are located on a top surface of the base.

7. The paddleboard trailer device of claim 6, wherein each of the pair of board receiving structures are comprised of a pair of vertical frame members and a horizontal frame member.

8. The paddleboard trailer device of claim 7, wherein the pair of board receiving structures are comprised of a support frame member.

9. A paddleboard trailer device comprising:
a base;
a board receiving structure comprised of a padding layer;
a roller;
a main storage box comprised of a hinge;
a cooler box;
an internal compartment;
a wheel;
an LED;
an axle;
an electrical box;
a trailer shaft comprised of a hitch;
a pair of turn signals; and
a strap.

10. The paddleboard trailer device of claim 9, wherein the electrical box is waterproof.

11. The paddleboard trailer device of claim 9 further comprised of a spare tire holder.

12. The paddleboard trailer device of claim 9, wherein the hitch is a female hitch.

13. The paddleboard trailer device of claim 9 further comprised of a rotatable support leg.

14. The paddleboard trailer device of claim 9, wherein the internal compartment is further comprised of two sections connected by a hinge.

15. The paddleboard trailer device of claim 13, wherein the internal compartment is secured via a lock.

16. The paddleboard trailer device of claim 9, wherein the main storage box is further comprised of a lock.

17. The paddleboard trailer device of claim 9, wherein the LED is located on the base.

18. The paddleboard trailer device of claim 9, wherein the strap is elastic.

19. The paddleboard trailer device of claim 9, wherein the board receiving structure is comprised of a pair of vertical frame members and a horizontal frame member.

20. The paddleboard trailer device of claim 19, wherein the roller rotates around the horizontal frame member.
